(19) United States
(12) Patent Application Publication
(10) Pub. No.: US 2018/0069235 A1
(43) Pub. Date: Mar. 8, 2018

(54) ANODE ACTIVE MATERIAL FOR SECONDARY BATTERY AND PREPARATION METHOD THEREOF

(71) Applicant: GS Energy Corp., Seoul (KR)

(72) Inventors: UngJu Lee, Seoul (KR); JongSoo Kim, Seoul (KR); Dongjoon Ahn, Seoul (KR)

(21) Appl. No.: 15/399,807

(22) Filed: Jan. 6, 2017

(30) Foreign Application Priority Data
Sep. 5, 2016 (KR) 10-2016-0114088

(51) Int. Cl. H01M 4/36; H01M 4/38; H01M 4/62; H01M 4/587; H01M 10/0525

(52) U.S. Cl. CPC H01M 4/366; H01M 4/386; H01M 2004/027; H01M 4/587; H01M 10/0525; H01M 4/625

(57) ABSTRACT

Disclosed are an anode active material for a secondary battery an a method for preparing the same, wherein the anode active material includes: a crystalline carbon particle; silicon-based nanoparticles, which are surface-coated with a first amorphous carbon layer and embedded into the crystalline carbon particle while being dispersed on a surface of the crystalline carbon particle; and a second amorphous carbon layer enclosing a surface of the crystalline carbon particle and the silicon-based nanoparticles, so a novel metal composite-based anode active material can be provided that has excellent life characteristics and high battery capacity.

### CROSS-REFERENCE TO RELATED APPLICATIONS

This application claims benefit and priority to Korean Patent Application No. 10-2016-0114088, filed on Sep. 5, 2016, with the Korean Intellectual Property Office, the disclosure of which is incorporated herein in its entirety by reference.

### TECHNICAL FIELD

The present disclosure relates to a novel metal composite-based anode active material for a secondary battery having excellent lifetime characteristics and high battery capacity, and to a method for preparing the same.

### BACKGROUND

A lithium secondary battery is widely used as a portable power supply of small-sized devices, such as cellular phones, notebook computers, and cameras. As the recent application of energy storage devices expands to the fields of vehicles, renewable energy, and smart grids, the application scope of lithium secondary batteries is also expanding.

For excellent lifetime characteristics of the lithium secondary batteries, there are known ways to coat an anode material with amorphous carbon or to increase conductivity of an anode material. In addition, for high battery capacity, there are known ways to use a metal oxide or a silicon oxide as an anode material.

Meanwhile, silicon (Si) receives a lot of attention as an anode material for a next-generation lithium secondary battery since it has: a low reaction potential with Li; a very high theoretical capacity of 4200 mAh/g compared with a carbon-based anode material; and excellent price competitiveness. However, the volume of silicon expands or shrinks by at least 4-fold due to the insertion and desorption of lithium ions during the charge and discharge cycles, causing deteriorations in battery lifetime characteristics and battery stability.

In order to solve the above-described problems of silicon electrode materials, research on electrode materials formed through a combination or micronization of silicon and carbon materials is being carried out. In addition, surface treatment for suppressing volume expansion of silicon, amorphization of silicon, oxidation for a silicon oxide composition, and the like have been known. However, these methods cannot also control the structural change caused by the volume change of an anode active material during continuous charge and discharge cycles, and they still have problems of reductions in battery capacitances and cycle characteristics due to the structural instability of an anode, such as delamination of active materials.

### SUMMARY

The present disclosure has been made to solve the above-mentioned problems occurring in the prior art.

More specifically, the present disclosure has been made based on the fact that an anode active material, in which silicon-based nanoparticles are embedded into a crystalline carbon particle while being dispersed on a surface of the crystalline carbon particle, can realize high battery capacity due to the presence of a silicon-based anode material, and can suppress volume expansion and improve lifetime characteristics through the high binding strength between the crystalline carbon particle and the silicon-based nanoparticles that are combined, in spite of continuous charge and discharge cycles.

Therefore, an aspect of the present disclosure is to provide a novel metal composite-based anode active material and a lithium secondary battery including the same.

In order to accomplish these objects, there is provided an anode active material for a secondary battery, comprising: a crystalline carbon particle; silicon-based nanoparticles, which are surface-coated with a first amorphous carbon layer and embedded into the crystalline carbon particle while being dispersed on a surface of the crystalline carbon particle; and a second amorphous carbon layer enclosing a surface of the crystalline carbon particle and the silicon-based nanoparticles.

Here, the crystalline carbon particle may be selected from natural graphite, artificial graphite, and mixtures thereof.

Here, the first and second amorphous carbon layers each may be independently selected from soft carbon, hard carbon, petroleum-based pitch carbide, charcoal-based pitch carbide, mesophase pitch carbide, calcined coke, amorphous carbon generated from carbonized gas, and mixtures thereof.

In accordance with another aspect of the present disclosure, there is provided a method for preparing the anode active material of the present disclosure, the method including: (i) putting crystalline carbon particles, silicon-based nanoparticles, a carbon material, a binding material, and a dispersant into an organic solvent, following stirring in a liquid phase, to prepare a mixture; (ii) removing the organic solvent from the mixture to obtain first composite particles in which the silicon-based nanoparticles coated with the carbon material are dispersed on a surface of each of the crystalline carbon particles; (iii) applying mechanical external force to the first composite particles to obtain second composite particles in the form in which the surface of the crystalline carbon particle is fused to surfaces of the silicon-based nanoparticles; and (iv) calcining the second composite particles at a temperature higher than the carbonization temperature of the second composite particles.

In accordance with still another aspect of the present disclosure, there is provided an anode for a secondary battery, including the anode active material, and a lithium secondary battery including the anode.

According to the metal composite-based anode material of the present disclosure, the silicon-based nanoparticles are uniformly distributed on the surface of the crystalline carbon particle, and at the same time, the binding strength between the surface of the crystalline carbon particle, the silicon-based nanoparticles, and the carbon material is high, thereby effectively suppressing the volume expansion of the silicon-based nanoparticles during the charge and discharge procedure and preventing the separation and deactivation of the silicon-based nanoparticles from the surface of the crystalline carbon particle in spite of continuous repetitive charge and discharge cycles, so that the metal composite-based anode material can exhibit excellent lifetime characteristics.

In addition, the high-capacity characteristics of the battery can be exhibited due to the use of silicon by using the composite particles of silicon and carbon material, and the performance of the anode material of the lithium secondary battery can be improved through excellent electrical conductivity by including the amorphous carbon layers enclosing the crystalline carbon particle and the silicon-based nanoparticles.

### BRIEF DESCRIPTION OF THE DRAWINGS

The above and other objects, features, and advantages of the present disclosure will be more apparent from the following detailed description taken in conjunction with the accompanying drawings, in which:

FIG. 1 is a schematic diagram showing a structure of an anode active material according to the present disclosure;

FIG. 2 is an SEM image of an anode active material particle prepared in example 1;

FIG. 3 is an SEM image of an anode active material particle prepared in comparative example 1;

FIG. 4 is an SEM image of an anode active material particle prepared in comparative example 2;

FIG. 5 is an SEM image of an anode active material particle prepared in comparative example 3;

FIG. 6 is a TEM image of the anode active material particle prepared in example 3;

FIG. 7 is an image showing a distribution of silicon-based nanoparticles positioned on the anode active material particle prepared in example 1;

FIG. 8 is a graph showing resistance changes for densities of the anode active materials prepared in example 1 and comparative example 3; and

FIG. 9 is a graph showing pore distribution plots of the anode active materials prepared in example 1 and comparative example 3.

### EXPLANATION OF REFERENCE NUMERALS AND SYMBOLS

1: a crystalline carbon particle
2: a silicon-based nanoparticle
3: a first amorphous carbon layer
4: a second amorphous carbon layer

### DETAILED DESCRIPTION OF THE PREFERRED EMBODIMENTS

The present disclosure is characterized by providing a novel anode active material, in which, while silicon and a carbon material are combined to form a Si—C metal composite-based anode active material, silicon nanoparticles and a crystalline carbon particle are combined through high binding strength therebetween.

More specifically, the anode active material has a structure in which the silicon-based nanoparticles are not simply attached to the crystalline carbon particle through physical contact or binding, but are partially embedded into the crystalline carbon particle while being dispersed on the surface of the crystalline carbon particle.

Therefore, such a structure can control the separation of silicon-based nanoparticles from carbon particles during charge and discharge, which is one of the biggest problems in the commercialization of silicon-carbon composite electrode materials in the conventional art, thereby stably maintaining long-lifetime characteristics of batteries.

In addition, according to the present disclosure, the amorphous carbon layers entirely enclose the surfaces of the silicon-based nanoparticles, surfaces between the silicon-based nanoparticles, and the surface of the crystalline carbon particle, thereby significantly improving the electrical conductivity of silicon.

Furthermore, the anode active material of the present disclosure includes a plurality of pores formed on a surface and/or in the inside of the anode active material. The plurality of pores act as spaces capable of relatively reducing the volume expansion of the silicon-based nanoparticles during charge and discharge, and thus can buffer the foregoing volume change of silicon and can further improve long-lifetime characteristics of the battery.

Hereinafter, a novel metal composite-based anode active material for a secondary battery and a method for preparing the same, according to the present disclosure, will be described in detail.

<Metal Composite-Based Anode Active Material for Secondary Battery>

A metal composite-based anode active material according to the present disclosure is in the form of a Si—C composite particle containing silicon (Si) and a carbon material (C).

More specifically, the anode active material includes: (a) a crystalline carbon particle; (b) silicon-based nanoparticles surface-coated with a first amorphous carbon layer; and (c) a second amorphous carbon layer enclosing the crystalline carbon particle and the silicon-based nanoparticles.

FIG. 1 schematically illustrates a cross-sectional structure of an anode active material according to an embodiment of the present disclosure.

Referring to FIG. 1, the anode active material has a structure including: a crystalline carbon particle 1; and silicon-based nanoparticles 2 surface-coated with a first amorphous carbon layer 3, wherein the silicon-based nanoparticles 2 are partially embedded into the crystalline carbon particle 1 while being dispersed on a surface of the crystalline carbon particle 1, and wherein the crystalline carbon particle 1 and the silicon-based nanoparticles 2 are enclosed in a second amorphous carbon layer 4.

In the anode active material according to the present disclosure, the crystalline carbon particle 1 may be a carbon material having a typical crystalline structure known in the art.

Non-limited examples of the crystalline carbon that may be used include natural graphite, artificial graphite, and mixtures thereof, and crystalline natural graphite is preferable. Here, the graphite may have an amorphous form, a plate form, a flake form, or a spherical form, and a spherical-shaped particle is preferable.

The average particle diameter of the crystalline carbon particle 1 is not particularly limited, and may be, for example, in the range of 3-30 μm, and preferably in the range of 5-20 μm.

In the present disclosure, as the silicon-based nanoparticles 2, which is combined with the crystalline carbon particle 1 to form the anode active material, a typical silicon-based material known in the art may be used without limitation, and examples thereof include silicon metals, silicon oxides, silicon alloys, silicon composites, and mixtures thereof.

Non-limited examples of the silicon material that may be used include Si, SiOx (0<x<2), Si—C composites, Si-Q alloys, and combinations thereof. Here, Q is an alkali metal, an alkali earth metal, an element of Groups 13-16, a transition metal, a rare earth element, or a combination thereof, and here, Si is excluded from Q. Specific examples of Q may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof. The silicon-based nanoparticle 2 may preferably be a silicon nanoparticle.

In the conventional art, an anode active material, in which silicon nanoparticles are distributed on a surface of a crystalline carbon particle, for example, a graphite particle, was developed. In this case, the silicon nanoparticles were simply attached to the surface of the graphite particle, and thus the rapid volume change of silicon cannot be suppressed during charge and discharge, and as a result, the silicon nanoparticles were delaminated, causing a significant deterioration in lifetime characteristics of batteries.

In comparison, the silicon-based nanoparticles 2 of the present disclosure are partially embedded into the crystalline carbon particle 1 while being dispersed on the surface of the crystalline carbon particle 1 (see FIG. 6). Such structural uniqueness increases the binding strength between the silicon-based nanoparticles 2 and the crystalline carbon particle 1, and thus, even though a remarkable volume change of the silicon-based nanoparticles occurs due to the continuous repetitive charge and discharge procedure, such a structure prevents the separation and deactivation of the silicon nanoparticles from the surface of the crystalline carbon particle, thereby attaining excellent lifetime characteristics of batteries.

In the present disclosure, any structure in which the silicon-based particles 2 are embedded into the crystalline carbon particle is not particularly limited. For example, the embedded depth of the silicon-based nanoparticles 2 into the crystalline carbon particle 1 may be in the range of approximately 0.5-1.5 μm (see FIG. 6).

In addition, when the crystallite size of silicon included in the anode active material is measured by X-ray diffractometry using CuKα radiation, the half-width of a (111) diffraction peak of Si may be in the range of 0.2° to 1.0°.

In addition, the average particle diameter of the silicon-based nanoparticles 2 may be 10-500 nm, preferably 30-300 nm, and more preferably 50-150 nm. The silicon-based nanoparticles (2) having an average particle diameter satisfying the above range can reduce the volume expansion rate while realizing a high capacity.

Generally, with the increase in the content of silicon, a higher capacity can be realized but the volume expansion rate increases. In the anode active material according to the present disclosure, the content ratio of the crystalline carbon particles 1, the silicon nanoparticles 2, and the first and second amorphous carbon layers may be 75-95:2.5-20:2.5-10 on the basis of weight percent, and preferably 85-90:5-15:5-7 on the basis of weight percent. Within the foregoing content range, high capacity and long-lifetime characteristics of batteries can be realized.

In the present disclosure, the silicon-based nanoparticle 2 comprises a first amorphous carbon layer 3 formed on a part or all of the surface of the silicon-based nanoparticle 2.

The first amorphous carbon layer 3 serves to primarily keep the shape of the silicon-based nanoparticle 2, and thus suppresses the volume expansion of silicon during charge and discharge, and imparts conductivity.

The first amorphous carbon layer 3 is not particularly limited, and may be made of, for example, soft carbon (low-temperature calcined carbon), hard carbon, petroleum-based pitch carbide, charcoal-based pitch carbide, mesophase pitch carbide, calcined coke, amorphous carbon generated from carbonized gas, or a mixture thereof.

In addition, the thickness of the first amorphous carbon layer 3 is not particularly limited, and the thickness thereof may be, for example, in the range of 1-50 nm, and preferably, in the range of 1-30 nm. In addition, the content of the first amorphous carbon layer 3 may be in the range of 0.1-3 wt % on the total weight of the anode active material, but is not particularly limited thereto.

The anode active material according to the present disclosure includes a second amorphous carbon layer 4, which is formed on the surfaces of the crystalline carbon particle 1 and the silicon-based nanoparticles 2 to enclose the both thereof.

The second amorphous carbon layer 4 may have a typical carbon component known in the art, and, for example, the component of the second amorphous carbon layer 4 may be the same as or different from that of the first amorphous carbon layer 3.

Non-limited examples of the second amorphous carbon layer 4 that may be used may be made of soft carbon, hard carbon, mesophase pitch carbide, calcined coke, amorphous carbon generated from carbonized gas, or a mixture thereof. The second amorphous carbon layer 4 serves to keep the shape of the anode material more strongly, and thus can control the volume change of the silicon anode material during charge and discharge, and can impart conductivity.

In addition, the thickness of the second amorphous carbon layer 4 is not particularly limited, and the thickness thereof may be for example in the range of 100-1500 nm, and preferably in the range of 200-1000 nm. In addition, the content of the second amorphous carbon layer 4 may be in the range of 1-10 wt % on the total weight of the anode active material, but is not particularly limited thereto.

The average particle diameter of the foregoing anode active material of the present disclosure may be within a normal range that the anode active material can be used as an electrode active material, for example in the range of 5-30 μm, and preferably in the range of 5-20 μm.

In the anode active material according to the present disclosure, a plurality of pores are formed on a surface and/or in the inside of the anode active material. The plurality of pores act as spaces, which can relatively reduce the volume expansion of silicon-based nanoparticles 2 caused during charge and discharge, thereby effectively controlling the foregoing volume change of silicon. In the anode active material, the volume of 5-100 nm-sized pores per particular weight may be 1×10⁻⁴ to 1.5×10⁻³ cm³/g·nm, preferably 2×10⁻⁴ to 1.0×10⁻³ cm³/g·nm, and more preferably 2×10⁻⁴ to 8×10⁻⁴ cm³/g·nm.

In addition, the specific surface area of the anode active material, measured by a nitrogen adsorption BET method, may be 3-15 m²/g, and preferably 6-11 m²/g.

In addition, the anode active material of the present disclosure includes the first amorphous carbon layer 3 and the second amorphous carbon layer 4, and thus has low resistance, thereby exhibiting excellent electrical conductivity. For example, the resistance of the anode active material may be in the range of 0.01-0.05Ω under conditions where a pressure for pellet density of 1.3˜1.6 g/cc is applied.

<Preparation Method for Metal Composite-Based Anode Active Material>

Hereinafter, a preparation method for a metal composite-based anode active material will be described according to the present disclosure. However, the method of the present disclosure is not limited to only the following preparation method, and respective process steps may be carried out by modification and selective mixing thereof as needed.

According to a preferable embodiment of the preparation method, the method may include: (i) putting crystalline carbon particles, silicon-based nanoparticles, a carbon material, a binding material, and a dispersant into an organic solvent, following stirring in a liquid phase, to prepare a mixture (“step S10”); (ii) removing the organic solvent from the mixture to obtain first composite particles in which the silicon-based nanoparticles coated with the carbon material are dispersed on a surface of each of the crystalline carbon particles (“step S20”); (iii) applying mechanical external force to the first composite particles to obtain second composite particles in the form in which the surface of the crystalline carbon particle is fused to surfaces of the silicon-based nanoparticles (“step S30”); and (iv) calcining the second composite particles at a temperature higher than the carbonization temperature of the second composite particles (“step S40”).

The method for preparing a metal composite-based anode active material according to the present disclosure will be described in detail by steps.

Hereinafter, 100 parts by weight of a mixture means 100 parts by weight of the entire mixture containing an organic solvent. And as needed, 100 parts by weight of a mixture may be 100 parts by weight of the overall solid excluding the organic solvent, the composition of the mixture is not limited to the following composition, and may be partly changed.

(1) Preparing Mixture (Hereinafter, Referred to as “Step S10”).

In step S10, a mixture for forming composite particles containing silicon and a carbon material is prepared.

In a preferable example of step S10, crystalline carbon particles, silicon-based nanoparticles, a carbon material, a binding material, and a dispersant are put into an organic solvent, following stirring in a liquid phase, to prepare a mixture.

Here, for the crystalline carbon particles, a crystalline carbon material that is known in the art may be used without limitation. Non-limited examples of the crystalline carbon particle that may be used include natural graphite, artificial graphite, and mixtures thereof. Crystalline natural graphite is preferable. Here, the graphite may have an amorphous form, a plate form, a flake form, or a spherical form, and, a spherical-shaped particle is preferable.

The use amount of the crystalline carbon particles is not particularly limited, and may be for example in the range of 50-70 parts by weight, preferably in the range of 55-70 parts by weight, and more preferably in the range of 60-70 parts by weight, on the basis of 100 parts by weight of the mixture. Herein, 100 parts by weight of a mixture may be 100 parts by weight of the overall solid excluding the organic solvent, the use amount of the crystalline carbon particles may be in the range of 60-85 parts by weight.

In addition, for the silicon-based nanoparticles, a typical silicon-based material known in the art may be used without limitation, and examples thereof include silicon nanoparticles, silicon oxides, silicon alloys, silicon composites, and mixtures of one or more thereof. The silicon nanoparticles may be preferable. Here, the use amount of the silicon-based nanoparticles is not particularly limited, and may be, for example, in the range of 2.5-20 parts by weight, preferably in the range of 5-15 parts by weight, and more preferably in the range of 5-10 parts by weight, on the basis of 100 parts by weight of the mixture.

In the present disclosure, as the carbon material, any material that can form an amorphous carbon layer by carbonization through calcining and, at the same time, can impart conductivity to silicon-based nanoparticles is not particularly limited.

As the carbon material, a typical hydrocarbon-based material known in the art may be used, and specific examples thereof may include epoxy resin, phenol resin, petroleum-based pitch, charcoal-based pitch, mesophase pitch, coal tar pitch, thermally treated pitch, furfural resin, urea formaldehyde resin, asphalt, citric acid, glucose, saccharose, polyacrylonitrile, polyethyleneglycol, polyvinylalcohol, and polyvinylchloride (PVC). Here, these may be used alone or in a mixture of two or more thereof.

In addition, the use amount of the carbon material is not particularly limited as long as the carbon material can bind the silicon-based nanoparticle and/or the crystalline carbon particles. The use amount of the carbon material may be, for example, in the range of 2.5-10 parts by weight, preferably in the range of 3-10 parts by weight, and more preferably in the range of 5-7 parts by weight, on the basis of 100 parts by weight of the mixture. A carbon material having the foregoing content range can sufficiently exhibit a desired binding effect.

In the present disclosure, the binding material physically binds the crystalline carbon particles, the silicon-based nanoparticles, and the carbon material, which constitute the anode active material, and enhances the adhesive strength therebetween.

As for the binding material, any material that exists as a solid at room temperature and has adhesive strength through drying and calcining is not particularly limited. Specific examples thereof may include glycolaldehyde, glyceraldehyde, dihydroxyacetone, threose, erythrose, erythrulose, ribose, arabinose, xylose, fructose, glucose, galactose, mannose, paraffin, triglyceride, phosphatide, and mixtures of one or more thereof.

The use amount of the binding material is not particularly limited, and may be for example in the range of 1-10 parts by weight, and preferably in the range of 1-5 parts by weight, on the basis of 100 parts by weight of the mixture.

In addition, in the present disclosure, the dispersant serves to attach the silicon-based nanoparticles, in a dispersed state, to the surface of the crystalline carbon particle.

As the dispersant, a surfactant known in the art may be used, and examples thereof include cationic surfactants, anionic surfactants, amphoteric surfactants, non-ionic surfactants, and mixtures of one or more thereof.

Specific examples thereof include ammonium lauryl sulfate, sodium lauryl sulfate, alkyl-ether sulfates, sodium laureth sulfate, dioctyl sodium sulfosuccinate, perfluorooctane sulfonate, perfluorobutane sulfonate, alkyl-aryl ether phosphates, alkyl ether phosphates, sodium stearate, sodium lauroyl sarcosinate, perfluorononanoate, perfluorooctanoate, octenidine dihydrochloride, cetrimonium bromide, cetylpyridinium chloride, benzalkonium chloride, benzethonium chloride, dimethyldioctadecylammonium chloride, dioctadecylmethylammonium bromide, phospholipid phosphatidylserine, phosphatidylethanolamine, phosphatidylcholine, sphingomyelins, polyoxyethylene glycol alkyl ethers, octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, polyoxyethylene glycol alkyl phenol ethers, glycerol alkyl esters, polyoxyethylene glycol sorbitan alkyl esters, sorbitan alkyl esters, cocamide MEA, cocamide DEA, dodecyldimethylamine oxide, poloxamers, polyethoxylated tallow amine, and mixtures of one or more thereof.

In the present disclosure, the use amount of the dispersant is not particularly limited, and may be for example in the range of 0.1-5 parts by weight, and preferably in the range of 1-2 parts by weight, on the basis of 100 parts by weight of the mixture.

As the organic solvent used when the foregoing components are mixed in a liquid phase, any normal organic solvent known in the art may be used without limitation. For example, alcohols, ketones, ethers, or mixtures of one or more thereof may be used as the organic solvent, and specific examples of the organic solvent include methanol, ethanol, ethylene glycol, N-propanol, isopropyl alcohol, 1,2-propylene glycol, 1.3-propylene glycol, glycerin, butanol, acetone, hexane, and mixtures thereof.

The use amount of the organic solvent is not particularly limited, and may be, for example, in the range of the residues satisfying 100 parts by weight of the mixture, and preferably in the range of 5-30 parts by weight.

According to an embodiment of the present disclosure, the composition of the mixture formed in step S10 may include, on the basis of 100 parts by weight of the mixture, 50-70 parts by weight of crystalline carbon particles; 2.5-20 parts by weight of silicon-based nanoparticles; 2.5-10 parts by weight of a carbon material; 1-10 parts by weight of a binding material; 0.1-5 parts by weight of a dispersant; and the balance organic solvent satisfying 100 parts by weight of the mixture. And preferably, the composition of the mixture may include, on the basis of 100 parts by weight of the mixture, 60-70 parts by weight of crystalline carbon particles; 5-15 parts by weight of silicon-based nanoparticles; 3-10 parts by weight of a carbon material; 1-5 parts by weight of a binding material; 1-2 parts by weight of a dispersant; and the balance organic solvent satisfying 100 parts by weight of the mixture.

In order to mix the mixture in a liquid phase more favorably, a normal mixer or stirrer known in the art may be used. Here, the mixing time is not particularly limited, and may be, for example, 1-5 hours.

(2) Obtaining First Composite Particles (Hereinafter, Referred to as “Step S20”)

In step S20, the organic solvent is removed from the liquid-phase mixture prepared in step S10, thereby obtaining first composite particles.

Here, the method of removing the organic solvent is not particularly limited, and may be carried out by using a typical method known in the art.

The first composite particles obtained in step S20 may have morphological features in which silicon-based nanoparticles coated with the carbon material are dispersed and attached on a surface of the crystalline carbon particle and the carbon material is uniformly coated on the resultant surface.

(3) Obtaining Second Composite Particles by Mechanical External Force (Hereinafter, Referred to as “Step S30”)

In step S30, the mechanical external force is applied to the first composite particles obtained in step S20. Here, the external force is adjusted within the range in which the first composite particles are not pulverized and the surfaces of the silicon-based nanoparticles can be fused to the surface of the crystalline carbon particle.

In step S30, as an apparatus for applying the mechanical external force, a mixing/pulverizing apparatus known in the art may be used without limitation. This apparatus enables the formation of second composite particles in the form in which the surface of the crystalline carbon particle is fused to the surfaces of the silicon-based nanoparticles, by employing a compressive force, an impact force, a shear force, and a frictional force.

The mixing and pulverizing may be performed by using any one method selected from the group consisting of mechanofusion milling, shaker milling, planetary milling, attritor milling, disk milling, shape milling, nauta milling, nobilta milling, high-speed mixing, and combinations thereof.

In addition, the time for mixing/pulverizing is not particularly limited, and may be properly adjusted within the linear velocity range of 20-30 m/s.

When a surface treatment processing process is performed using the mechanical apparatus as above, second composite particles, in which the silicon-based nanoparticles surface-coated with the carbon material are partially embedded into the crystalline carbon particle while being dispersed on the surface of the crystalline carbon particle and the resultant surface is coated with the carbon material, can be formed.

(4) Carbonizing Through Calcining (Hereinafter, Referred to as “Step S40”)

In step S40, the second composite particles formed in step S30 are calcined, thereby fixing and stabilizing the carbon material, which exists on the surface of the second composite particles, to the surface of the second composite particles, and achieving carbonization, impurity removal, and surface improvement.

Here, the temperature for thermal treatment is not particularly limited as long as the temperature is not lower than a temperature at which the carbon material is carbonized. The calcining may be carried out, for example, in the temperature range of 600-1500° C., and preferably in the temperature range of 800-1300° C., for 20 minutes to 72 hours. Here, when the temperature for thermal treatment is within the above range, the carbon material can be sufficiently carbonized, and the impurities in the anode active material can be completely removed.

In the present disclosure, through the thermal treatment step, the carbon material, which is coated on the surfaces of the silicon-based nanoparticles and on the surface of the silicon-based nanoparticles and the crystalline carbon particle, is carbonized while the impurities therein are removed, and then the carbon material is made into hard carbon, so that the overall coating layers are stabilized and the coatability is improved.

After the thermal treatment above, a second thermal step may be further carried out in the temperature range of 1000-3,000° C., and preferably 1000-1500° C., for 30 minutes to 72 hours, for the improvement in crystallinity/uniformity of the crystalline carbon material and the improvement in the surface property of the first and second amorphous carbon layers.

(5) Sorting Calcined Material (Hereinafter, Referred to as “Step S50”)

As needed, the present disclosure may further include a step for sorting the material calcined in step S40.

In the sorting step, from the calcined silicon-carbon composite particle anode active material, fine particles out of a predetermined size are discharged and removed to the outside, or bulky particles of a predetermined size or larger are discharged and removed to the outside. Here, the sorting reference for the removal as a fine particle may be not larger than the size that can be used as an anode material for a secondary battery (average particle diameter), and the sorting reference for the removal as a bulky particle may be not smaller than the average particle diameter. Here, the average particle diameter of the anode material may be in the range of 5-30 μm.

As a preferable example of step S50, the calcined material is sorted by using a sorter known in the art, and then the second thermal treatment step may be carried out as needed. Here, examples of the sorter that may be used include a high-speed rotary sorter, an ultrasonic sorter, a jet type sorter, and the like.

<Anode Material and Lithium Secondary Battery>

Furthermore, the present disclosure provides an anode material for a secondary battery containing the foregoing anode active material, and a lithium secondary battery including the anode material.

Here, the requirement for the anode material of the present disclosure is that the anode material includes, as an anode active material, a silicon/carbon composite particle having a structure in which silicon-based nanoparticles are embedded into at least the above-described crystalline carbon particle. For example, the silicon/carbon composite particles per se may be used as an anode active material. Alternatively, an anode mixture in which the silicon/carbon composite particles are mixed with a binder, an anode mixture paste obtained by adding a solvent to the anode mixture, and an anode formed by coating the anode mixture paste on a current collector are within the range of the anode material of the present disclosure.

The anode may be manufactured by a typical method known in the art. For example, as occasion demands, a binder, a conducting agent, and a dispersant are mixed with the electrode active material, followed by stirring, to prepare a slurry, and then the slurry is applied (coated) on a current collector, followed by compressing and drying, thereby manufacturing an anode.

Here, as the electrode materials, such as a dispersion medium, a binder, a conducting agent, and a current collector, typical electrode materials known in the art may be used. Compared with the electrode active material, the binder may be properly used in the range of a weight ratio of 1-10 and the conductive material in the range of a weight ratio of 1-30.

Examples of the conductive agent that may be used include carbon black, acetylene black series (Gulf Oil Company), Ketjen Black, Vulcan XC-72, Super P, and the like.

In addition, representative examples of the binder include polytertrafluoroethylene (PTFE), polyvinylidene fluoride (PVdF) or copolymers thereof, styrene-butadiene rubber (SBR), cellulose, polyacrylic acid, and the like. Representative examples of the dispersant include isopropyl alcohol, N-methylpyrrolidone (NMP), acetone, and water.

As the current collector of a metal material, any metal that has high conductivity, allows easy attachment of the paste of the above materials thereto, and has no reactivity in the voltage range of the battery may be used. For example, a mesh or foil of aluminum, copper, or stainless steel may be used.

Furthermore, the present disclosure provides a secondary battery including the electrode, preferably a lithium secondary battery.

The secondary battery of the present disclosure is not particularly limited except that the foregoing silicon/carbon composite particles having a structure in which silicon-based nanoparticles are embedded on a crystalline carbon particle are used, and the secondary battery of the present disclosure may be manufactured by a normal method known in the art. For example, the secondary battery of the present disclosure may be manufactured by inserting a separator between a cathode and an anode and putting a non-aqueous electrolyte thereinto.

Here, the secondary battery of the present disclosure includes, as battery elements, a cathode, an anode, a separator, and an electrolyte, and here, the components of the cathode and the separator, and as needed, other additives, excluding the foregoing anode are based on the components for a typical lithium secondary battery known in the art.

For example, the cathode may be made by using a typical cathode active material for a lithium secondary battery known in the art, and non-limited examples thereof include lithium transition metal composite oxides, such as LiMₓO_{y} (M=Co, Ni, Mn, CoₐNi_{b}Mn_{c}) (e.g. lithium manganese composite oxides such as LiMn₂O₄, lithium nickel oxides such as LiNiO₂, lithium cobalt oxides such as LiCoO₂, other oxides obtained by substituting manganese, nickel and cobalt in the above oxides partially with other normal transition metals or aluminum, lithium-containing vanadium oxide, etc.); and chalcogen compounds (e.g., manganese dioxide, titanium disulfide, molybdenum disulfide, etc).

In addition, the non-aqueous electrolyte includes electrolyte components known in the art, for example, an electrolyte salt and an electrolyte solvent.

The electrolyte salt may be composed of a combination of (i) a cation selected from the group consisting of Li⁺, Na⁺, and K⁺ and (ii) an anion selected from the group consisting of PF₆—, BF₄—, Cl—, Br—, I—, ClO₄, AsF₆—, CH₃CO₂—, CF₃SO₃—, N(CF₃SO₂)₂— and C(CF₂SO₂)₃—, and of theses, a lithium salt is preferable. Specific examples of the lithium salt include LiClO₄, LiCF₃SO₃, LiPF₆, LiBF₄, LiAsF₆, and LiN(CF₃SO₂)₂. These electrolyte salts may be used alone or in a mixture of two or more thereof.

As the electrolyte solvent, a cyclic carbonate, linear carbonate, lactone, ether, ester, acetonitrile, lactam, or ketone may be used.

Examples of the cyclic carbonate include ethylene carbonate (EC), propylene carbonate (PC), butylene carbonate (BC), and fluoroethylene carbonate (FEC), and the examples of the linear carbonate include diethyl carbonate (DEC), dimethyl carbonate (DMC), dipropyl carbonate (DPC), ethyl methyl carbonate (EMC), and methyl propyl carbonate (MPC). Examples of the lactone include gamma-butyrolactone (GBL), and the examples of the ether include dibutyl ether, tetrahydrofuran, 2-methyltetrahydrofuran, 1,4-dioxane, 1,2-dimethoxy ethane, and 1,2-diethoxy ethane. Examples of the ester may include methyl formate, ethyl formate, propyl formate, methyl acetate, ethyl acetate, propyl acetate, methyl propionate, ethyl propionate, butyl propionate, and methyl pivalate. In addition, examples of the lactam include N-methyl-2-pyrrolidone (NMP), and examples of the ketone include polymethylvinyl ketone. In addition, the halogen derivatives of the organic solvent may also be used, but the present disclosure is not limited thereto. Furthermore, as the organic solvent, glyme, diglyme, triglyme, or tetraglyme may also be used. These organic solvents may be used alone or in a mixture of two or more thereof.

For the separator, any porous material that serves to block an inner short circuit of both electrodes and is impregnated with an electrolyte may be used without limitation. Non-limited examples thereof include polypropylene-based, polyethylene-based, and polyolefin-based porous separators, or may include composite separators obtained by adding an inorganic material to the porous separators.

Hereinafter, the present disclosure is described in detail through the examples. However, these examples are only for illustrating the present disclosure more specifically, and it will be apparent to those skilled in the art that the scope of the present disclosure is not limited by these examples.

### Example 1: Preparation of Anode Active Material

1-1. Preparation of Anode Active Material

A mixture, which was obtained by mixing 80 wt % of natural graphite particles with an average particle diameter of 13 μm as crystalline carbon particles, 10 wt % of silicon nanoparticles with an average particle diameter of 150 nm on the basis of the total weight of the mixture (solid) excluding an organic solvent, 1 wt % of polyoxyethylene glycol octyl phenol ether as a dispersant, 7 wt % of pitch as a carbon material, and 2 wt % of paraffin as a binding material, was put into isopropyl alcohol, followed by mixing with stirring in a liquid phase for 3 hours. Thereafter, the isopropyl alcohol was completely evaporated from the mixture to give composite particles. The composite particles were put in a mechanofusion apparatus, surface-treated at 2,500 rpm for 30 minutes, calcined at 1,000° C., and then sorted using a 400 mesh, thereby preparing an anode active material of example 1.

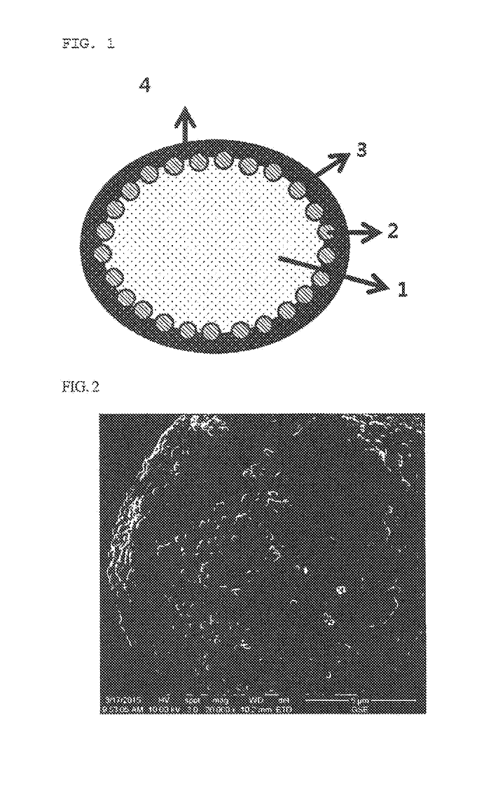

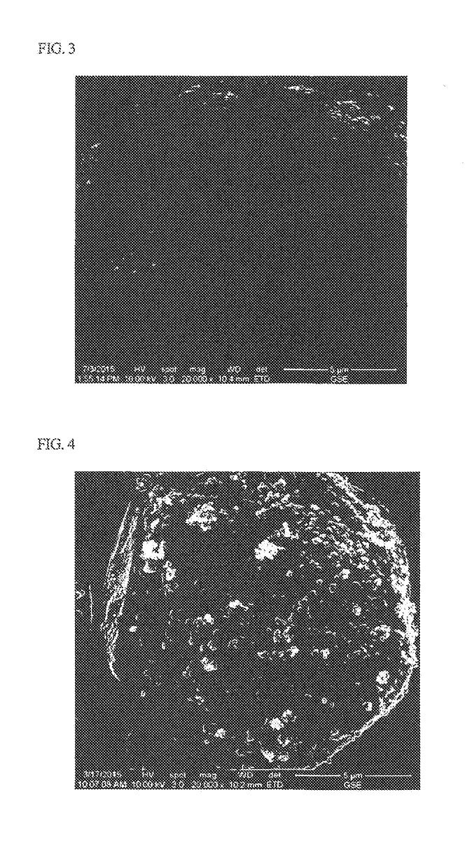

An SEM image of the anode active material of example 1 prepared above is shown in FIG. 2.

1-2. Manufacture of Secondary Battery

An electrode was manufactured through a slurry casting method using a mixture of 90 parts by weight of the metal composite-based anode active material prepared in example 1-1, 6 parts by weight of a binder, and 4 parts by weight of a conducting agent. This was coated on a copper foil as a current collector, followed by drying and rolling press, to manufacture an electrode. The above metal composite-based anode active material-containing electrode, a lithium metal used as a counter electrode, and EC/DEC/FEC (=25/60/15 wt %) in which 1 M LiPF₆ was dissolved, used as an electrolyte, were allowed to constitute a 2016 coin cell battery, and performances thereof were evaluated at room temperature. The charge and discharge was carried out while a voltage of 0.005 V to 1.5 V was applied and the current range was 1.3 mA (0.2 C), and the 0.2 C discharge capacity was measured as the initial discharge capacity. In addition, as for the lifetime characteristics, the charge and discharge was carried out at 6.5 mA (1.0 C) to measure the capacity retention rate after 50 cycles.

### Example 2

An anode active material of example 2 was prepared by the same method as in example 1 except that 6 wt % of pitch, instead of 7 wt % of pitch, was used as a carbon material, and then a secondary battery including the anode active material was manufactured.

### Example 3

An anode active material of example 3 was prepared by the same method as in example 1 except that 5 wt % of pitch, instead of 7 wt % of pitch, was used as a carbon material, and then a secondary battery including the anode active material was manufactured.

A TEM image of the anode active material of example 3 prepared above is shown in FIG. 6.

### Example 4

An anode active material of example 4 was prepared by the same method as in example 1 except that 2 wt % of pitch, instead of 7 wt % of pitch, was used as a carbon material, and then a secondary battery including the anode active material was manufactured.

### Example 5

An anode active material of example 5 was prepared by the same method as in example 1 except that 5 wt % of paraffin, instead of 2 wt % of paraffin, was used as a binding material and 5 wt % of pitch, instead of 7 wt % of pitch, was used as a carbon material.

An anode and a secondary battery including the anode were manufactured using the anode active material of example 5.

### Comparative Example 1

A mixture, which was obtained by mixing 89 wt % of natural graphite particles with an average particle diameter of 13 μm as crystalline carbon particles, 10 wt % of silicon nanoparticles with an average particle diameter of 150 nm on the basis of the total weight of the mixture, and 1 wt % of a surfactant as a dispersant, was put into isopropyl alcohol, followed by mixing with stirring in a liquid phase for 3 hours. Thereafter, the isopropyl alcohol was completely evaporated from the mixture to give composite particles. The composite particles were put in a mechanofusion apparatus, surface-treated, calcined at 1,000° C., and then sorted using a 400 mesh, thereby preparing an anode active material of comparative example 1. An SEM image of the anode active material of comparative example 1 prepared above is shown in FIG. 3.

A secondary battery was manufactured by the same method as in example 1 except that the foregoing anode active material of comparative example 1 was used.

### Comparative Example 2

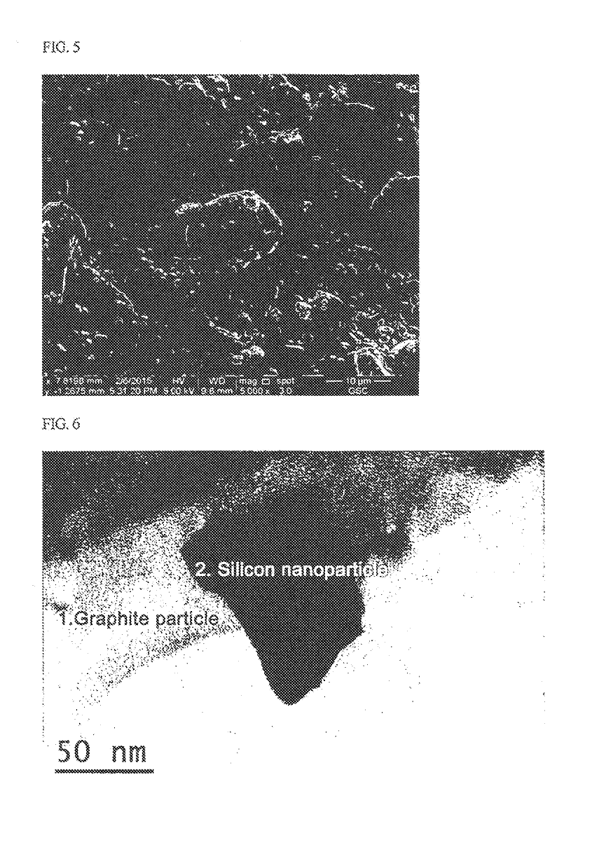

A mixture, which was obtained by mixing 84 wt % of natural graphite particles with an average particle diameter of 13 μm as crystalline carbon particles, 10 wt % of silicon nanoparticles with an average particle diameter of 150 nm on the basis of the total weight of the mixture, 1 wt % of a surfactant as a dispersant, and wt % of pitch as a carbon material, was put into isopropyl alcohol, followed by mixing with stirring in a liquid phase for 3 hours. Thereafter, the isopropyl alcohol was completely evaporated from the mixture to give composite particles. The composite particles were put in a mechanofusion apparatus, surface-treated, calcined at 1,000° C. and then sorted using a 400 mesh, thereby preparing an anode active material of comparative example 2. An SEM image of the anode active material of comparative example 2 prepared above is shown in FIG. 4.

A secondary battery was manufactured by the same method as in example 1 except that the foregoing anode active material of comparative example 2 was used.

### Comparative Example 3

A mixture, which was obtained by mixing 80 wt % of natural graphite particles with an average particle diameter of 13 μm as crystalline carbon particles, 10 wt % of silicon nanoparticles with an average particle diameter of 150 nm on the basis of the total weight of the mixture, 1 wt % of a surfactant as a dispersant, and 2 wt % of paraffin as a binding material, was put into isopropyl alcohol, followed by mixing with stirring in a liquid phase for 3 hours. Thereafter, the isopropyl alcohol was completely evaporated from the mixture to give composite particles. 7 wt % of pitch as a carbon material was added to the composite particles, mixed in a mixer, calcined at 1,000□, and then sorted using a 400 mesh, thereby preparing an anode active material of comparative example 3. An SEM image of the anode active material of comparative example 3 prepared above is shown in FIG. 5.

A secondary battery was manufactured by the same method as in example 1 except that the foregoing anode active material of comparative example 3 was used.

### Test Example 1: Evaluation on Physical Properties of Anode Active Material

The surfaces of the anode active materials prepared in comparative examples 1-3 and examples 1 and were checked through scanning electron microscopy (SEM) and transmission electron microscopy (TEM).

FIG. 2 is an SEM image of the anode active material particle prepared in example 1.

Specifically, it could be verified from FIG. 2 that the carbon material and the silicon nanoparticles were coated on a surface of the graphite particle as a crystalline carbon particle. It is determined that the conductivity of the silicon nanoparticles can be increased by the carbon material existing on the surface; the local volume expansion can be minimized by a uniform distribution of the silicon nanoparticles; and the volume expansion of the anode material can be suppressed by the strong binding strength between the surface of the silicon nanoparticle and the surface of the crystalline carbon particle, in spite of continuous charge and discharge.

FIGS. 3 to 5 are SEM images of the anode active materials prepared in comparative examples 1 to 3.

Specifically, it is determined that, as for the anode active material of comparative example 1, the silicon nanoparticles were uniformly dispersed on the surface of the graphite particle as the crystalline carbon particle, but the absence of pitch as a carbon material did not produce a coating effect of imparting conductivity to the silicon nanoparticles.

In addition, it could be seen that, as for the anode active material of comparative example 2, the silicon nanoparticles were not uniformly coated on the carbon material rather than on the surface of the graphite particle, and the silicon nanoparticles agglomerated locally. Therefore, it is determined that the volume expansion of the silicon nanoparticles cannot be suppressed.

In addition, it could be seen that, as for the anode active material of comparative example 3, the silicon nanoparticles were not coated on the surface of the graphite particle, but co-exist, in an agglomerated state, together with the graphite particle.

FIG. 6 is a TEM image of the anode active material particle prepared in comparative example 3. It could be seen from the TEM image of FIG. 6 that the silicon nanoparticle was partially embedded into the graphite particle as the crystalline carbon particle, instead of being attached to the surface of the graphite particle.

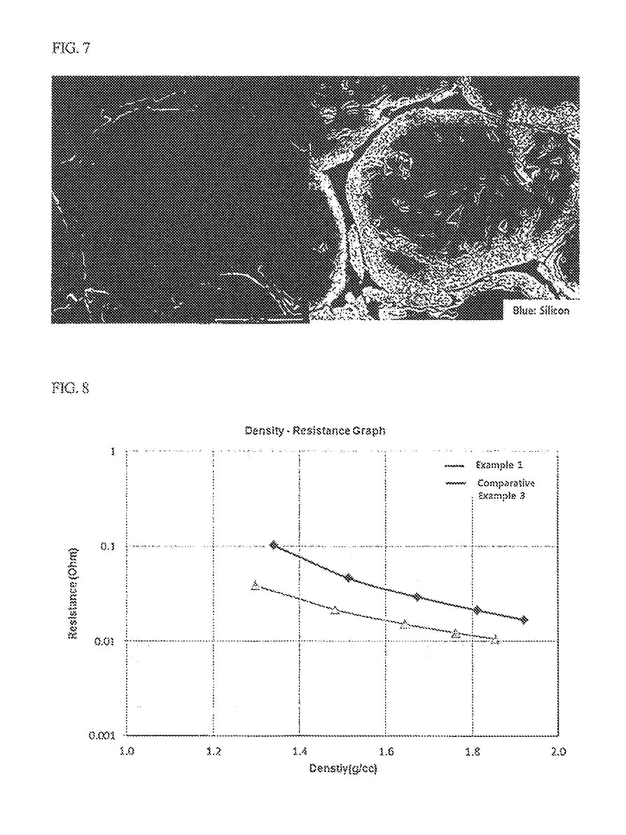

FIG. 7 shows morphological analysis results (SEM) and component analysis results (EDS) after a cross section of the electrode manufactured in example 1 was cut (cross section polisher). Specifically, it could be seen that, as a result of confirming the distribution of silicon nanoparticles positioned on the anode active material particle, the silicon nanoparticles were distributed on a surface and in the inside of the crystalline carbon particle.

### Test Example 2: Evaluation on Electrical Conductivity of Anode Active Material

Electrical conductivity was measured using the anode active materials prepared in example 1 and comparative example 3.

Here, the electrical conductivity was measured using PD-51 of Mitsubishi Chemical. Specifically, pellets were manufactured using 2 g of an anode active material, and then the density and resistance of a corresponding pellet were respectively measured under conditions of a pressure of 4 kN, 8 kN, 12 kN, 16 kN, and 20 kN. The results are shown in Table 1 below and FIG. 8.

For reference, the pellet density may vary depending on the kind of anode active material even though the same pressure is applied, and thus the following resistance values were compared under the same density conditions.

TABLE 1

| | |
|---|---|
| | Reistance ratio |
| Resistance (Ohm) | (Example 1/ |

| Pellet density | | Comparative | Comparative |
|---|---|---|---|
| (g/cc) | Example 1 | example 3 | example 3, %) |
| 1.3 | 0.039 | 0.109 | 35.8 |
| 1.4 | 0.028 | 0.075 | 37.3 |
| 1.5 | 0.022 | 0.054 | 40.7 |
| 1.6 | 0.017 | 0.039 | 43.6 |

It could be seen from the test results that the anode active material of example 1 had excellent electrical conductivity since the resistance of the anode active material of example 1 was lower than that of the anode active material of comparative example 3 by at least 50%. This is assumed to be due to the structure in which the carbon material, as the first amorphous carbon layer, is coated on the silicon-based nanoparticles during the combining procedure, and the carbon material, as the second amorphous carbon layer, is also coated on the graphite particle as crystalline carbon through surface treatment using a mechanofusion apparatus before calcining.

### Test Example 3: Evaluation on Porosity of Anode Active Material

The pore distribution in the anode active materials prepared in example 1 and comparative example 3 was investigated.

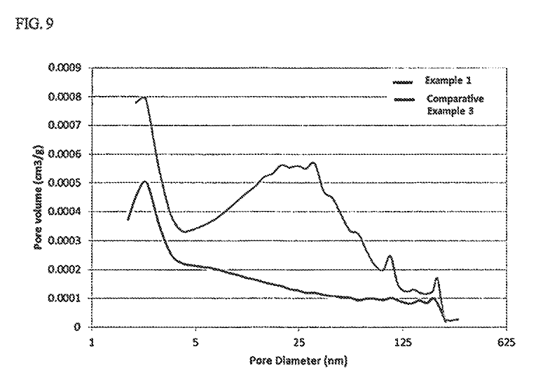

Here, the specific surface area was measured using nitrogen as adsorption gas in a pressure section of 0.0001-1.0 after 1.5 g of the anode active material was pre-treated at 130□ for 3 hours, and then the pore distribution was analyzed by the BJH method. The measured pore distribution is shown in FIG. 9.

It could be seen that a plurality of 5- to 100-nm-sized pores were formed in the anode active material of example 1, unlike the anode active material of comparative example 3. It is determined that the plurality of pores distributed in the anode active material are ensured as spaces capable of relatively reducing the volume expansion of the silicon nanoparticles caused during charge and discharge, and such a structure will be favorable for lifetime characteristics of secondary batteries including the anode active material.

### Test Example 4: Evaluation on Electrode Expansion Rate of Second Battery

The volume expansion rates of electrodes including the anode active materials prepared in examples 1-3 and comparative example 2 were evaluated as follows.

Here, as for the volume expansion rate, the coin cell was disassembled in the charged state after 50 cycles, the electrode was washed with salt-free DMC, the electrolyte on the surface of the electrode was volatilized, and then the thickness of the electrode was measured. Here, the electrode expansion rate was measured using equation 1 below:

Electrode expansion (%)=(thickness of electrode after 50 cycles of charge−initial thickness of electrode)/(initial thickness of electrode−Cu foil thickness)×100 [Equation 1]

TABLE 2

| | Components of anode (wt %) | | | | Volume |
|---|---|---|---|---|---|
| | Nano- | | Binding | Carbon | expansion |
| | silicon | Dispersant | material | material | rate (%) |
| Comparative | 15 | 1 | 0 | 5 | 244 |
| example 2 | | | | | |
| Example 1 | 15 | 1 | 5 | 10 | 163 |
| Example 2 | 15 | 1 | 5 | 7 | 169 |
| Example 3 | 15 | 1 | 5 | 5 | 182 |

It can be seen from the test results that the volume expansion rate of an electrode according to charge and discharge was significantly reduced in the electrodes of examples 1-3 compared with comparative example 2, and thus the electrodes of examples 1-3 had an excellent volume expansion inhibitory effect (see table 2).

Especially, it can be seen that, as a result of comparing performance between the anode active materials of comparative example 2 and example 3 using the same amount of the carbon material, as for the anode active material of comparative example 2 having no binding material, the silicon nanoparticles are not well bound to the surface of the crystalline carbon particle and agglomerate without uniform dispersion, and thus relatively shows a large volume expansion rate resulting from the silicon nanoparticles agglomerating at the time of charge.

### Test Example 5: Evaluation on Performance of Secondary Battery

The performances of secondary batteries including the anode active materials prepared in examples 1-5 and comparative examples 1-3 were evaluated as follows.

(1) Initial capacity: Discharge capacity after one cycle of charge

(2) Initial efficiency: Ratio of discharge capacity to charge capacity in the first cycle

(3) Lifetime characteristics: Retention ratio of 50th cycle discharge capacity to 1st cycle discharge capacity after 50 cycles of charge and discharge

TABLE 3

| | | | | | Battery performance | | |
|---|---|---|---|---|---|---|---|
| | Components of anode (wt %) | | | | Initial | Iniial | Lifetime |
| | Nano- | | Binding | Carbon | capacity | efficiency | Characteristics |
| | silicon | Dispersant | material | Material | (mAh/g) | (%) | (%) |
| Comparative | 15 | 1 | 0 | 0 | 770 | 86.0 | 25 |
| Example 1 | | | | | | | |
| Comparative | 15 | 1 | 0 | 5 | 754 | 87.6 | 61.9 |
| Example 2 | | | | | | | |
| Comparative | 15 | 1 | 5 | 10 | 732 | 90.1 | 46.6 |
| Example 3 | | | | | | | |
| Example 1 | 15 | 1 | 5 | 10 | 733 | 89.9 | 63 |
| Example 2 | 15 | 1 | 5 | 7 | 737 | 89.5 | 67 |
| Example 3 | 15 | 1 | 5 | 5 | 759 | 88.6 | 68 |
| Example 4 | 15 | 1 | 5 | 3 | 764 | 87.2 | 78 |
| Example 5 | 15 | 1 | 10 | 5 | 756 | 88.7 | 63.9 |

As a test result, the anode active material of comparative example 3, which was prepared by combining the crystalline carbon particle, the silicon nanoparticles, the dispersant, and the binding material and then putting the carbon material thereinto, exhibited poor-lifetime characteristics compared with the anode active material of example 1, which was prepared by putting the foregoing anode components at the same time and combining the components. It is assumed that, in comparative example 3, the silicon nanoparticles and the carbon material are not sufficiently mixed in the combining step, so the carbon that imparts conductivity is not coated on the surfaces of the silicon-based nanoparticles, and the silicon-based nanoparticles are simply attached to the surface of the crystalline carbon particle, so the volume expansion of silicon-based nanoparticles is not continuously suppressed during charge and discharge, and thus the lifetime characteristic of the battery deteriorate.

The anode active materials of examples 1-5 showed long-lifetime characteristics of the battery (see table 3). It could be verified that, particularly, the regulation of the content of the carbon material can further improve the lifetime characteristics of the battery, and specifically, the lower the content of the carbon material, the longer the lifetime characteristics of the battery.

What is claimed is:

1. An anode active material for a secondary battery, comprising:
a crystalline carbon particle;
silicon-based nanoparticles, which are surface-coated with a first amorphous carbon layer and embedded into the crystalline carbon particle while being dispersed on a surface of the crystalline carbon particle; and
a second amorphous carbon layer enclosing the surfaces of the crystalline carbon particle and the silicon-based nanoparticles.

2. The anode active material of claim 1, wherein the crystalline carbon particle is a spherical particle with an average particle diameter of 3-30 μm.

3. The anode active material of claim 1, wherein the silicon-based nanoparticles are selected from Si, SiOx (0<x<2), Si—C composites, Si-Q alloys (Q: an alkali metal, an alkali earth metal, an element of Groups 13-16, a transition metal, a rare earth element, or a combination thereof; and Si is excluded from Q) and combinations thereof.

4. The anode active material of claim 1, wherein the silicon-based nanoparticles have an average particle diameter of 10-500 nm.

5. The anode active material of claim 1, wherein the content ratio of the crystalline carbon particle, the silicon-based nanoparticles, and the first and second amorphous carbon layers, in the anode active material, is a weight ratio of 75-95:2.5-20:2.5-10.

6. The anode active material of claim 1, wherein the thickness of the first amorphous carbon layer is 1-50 nm, and
wherein the thickness of the second amorphous carbon layer is 100-1500 nm.

7. The anode active material of claim 1, wherein the specific surface area measured by a nitrogen adsorption BET method is 3-15 m²/g.

8. The anode active material of claim 1, wherein the anode active material includes a plurality of pores formed on a surface or in the inside thereof, the volume of 5- to 100-nm-sized pores per particle weight being 1×10⁻⁴ to 1.5×10⁻³ cm³/g·nm.

9. The anode active material of claim 1, wherein the anode active material has a resistance of 0.01-0.05Ω under conditions where a pressure for a pellet density of 1.3˜1.6 g/cc is applied.

10. An anode for a secondary battery, comprising the anode active material of claim 1.

11. A lithium secondary battery comprising: an anode comprising the anode active material of claim 1; a cathode; a separator; and an electrolyte.

12. A method for preparing the anode active material of claim 1, the method comprising:
(i) putting crystalline carbon particles, silicon-based nanoparticles, a carbon material, a binding material, and a dispersant into an organic solvent, following stirring in a liquid phase, to prepare a mixture;
(ii) removing the organic solvent from the mixture to obtain first composite particles in which the silicon-based nanoparticles coated with the carbon material are dispersed on a surface of each of the crystalline carbon particles;
(iii) applying mechanical external force to the first composite particles to obtain second composite particles in the form in which the surface of the crystalline carbon particle is fused to surfaces of the silicon-based nanoparticles; and
(iv) calcining the second composite particles at a temperature higher than the carbonization temperature of the second composite particles.

13. The method of claim 12, wherein the carbon material in step (i) is selected from the group consisting of epoxy resin, phenol resin, petroleum-based pitch, charcoal-based pitch, furfural resin, urea formaldehyde resin, asphalt, citric acid, glucose, saccharose, polyacrylonitrile, polyethyleneglycol, polyvinylalcohol, and polyvinylchloride (PVC).

14. The method of claim 12, wherein the binding material in step (i) is selected from the group consisting of glycolaldehyde, glyceraldehyde, dihydroxyacetone, threose, erythrose, erythrulose, ribose, arabinose, xylose, fructose, glucose, galactose, mannose, paraffin, triglyceride, and phosphatide.

15. The method of claim 12, wherein the mixture in step (i) comprises:
on the basis of 100 parts by weight thereof,
50-70 parts by weight of crystalline carbon particles;
2.5-20 parts by weight of silicon-based nanoparticles;
2.5-10 parts by weight of a carbon material;
1-10 parts by weight of a binding material;
0.1-5 parts by weight of a dispersant; and
the balance organic solvent satisfying 100 parts by weight of the mixture.
